(19) United States
(12) Patent Application Publication
(10) Pub. No.: US 2022/0328828 A1
(43) Pub. Date: Oct. 13, 2022

(54) ELECTROCHEMICAL DEVICE AND ELECTRONIC DEVICE

(71) Applicant: Ningde Amperex Technology Limited, Ningde (CN)

(72) Inventor: Jian WU, Ningde (CN)

(73) Assignee: Ningde Amperex Technology Limited, Ningde (CN)

(21) Appl. No.: 17/705,633

(22) Filed: Mar. 28, 2022

(30) Foreign Application Priority Data
Mar. 30, 2021 (CN) 202110340362.5

(51) Int. Cl. H01M 4/583; H01M 4/505; H01M 4/525

(52) U.S. Cl. CPC H01M 4/583; H01M 4/505; H01M 4/525; H01M 2004/028

(57) ABSTRACT

An electrochemical device includes an electrode assembly. The electrode assembly includes a positive electrode plate. The positive electrode plate includes a positive current collector and a positive active material layer disposed on the positive current collector. The positive active material layer includes a positive active material and graphene. At least a part of the graphene is disposed on surfaces of particles of the positive active material. The technical solution of this application not only increases a compacted density of the positive active material layer and an energy density of the electrochemical device, but also reduces polarization and increases charging speed of the electrochemical device.

### CROSS-REFERENCE TO RELATED APPLICATIONS

This application claims priority to Chinese Patent Application No. 202110340362.5, filed on Mar. 30, 2021, the whole disclosure of which is incorporated herein by reference.

### TECHNICAL FIELD

This application relates to the technical field of electronics, and in particular, to an electrochemical device and an electronic device.

### BACKGROUND

With the wide use of electrochemical devices (such as a lithium-ion battery) in various electronic products, users have posed higher requirements on an energy density and fast charge performance of the electrochemical devices. Generally, the fast charge performance of an electrochemical device may be improved by reducing a particle diameter of a positive active material, optimizing an electrolytic solution, increasing a lithium intercalation activity of a negative electrode, and the like. However, the reduction of the particle diameter of the positive active material usually leads to decrease of a compacted density of a positive electrode plate, thereby decreasing the energy density of an entire electrode assembly. The optimization of the electrolytic solution and the increase of the lithium intercalation activity of the negative electrode usually deteriorate the high-temperature performance, and adversely affect safety and stability of the electrode assembly.

Therefore, although the current technology for improving the electrochemical devices can enhance the fast charge performance of the electrochemical devices to some extent, the improvement is still unable to meet people's higher requirements, and more improvements are urgently needed.

### SUMMARY

An embodiment of this application provides an electrochemical device, including an electrode assembly. The electrode assembly includes a positive electrode plate. The positive electrode plate includes a positive current collector and a positive active material layer disposed on the positive current collector. The positive active material layer includes a positive active material and graphene. At least a part of the graphene is disposed on surfaces of particles of the positive active material.

In some embodiments, the positive active material includes primary particles having Dᵥ₅₀≤9 μm and Dᵥ₉₀≤20 μm. In some embodiments, the positive active material includes secondary particles of which Dᵥ₅₀≤6 μm and Dᵥ₉₀≤15 μm.

In some embodiments, based on a mass of the positive active material layer, a mass percent of the graphene is 0.05% to 1%. In some embodiments, with respect to the particles of the positive active material, Dᵥ₉₀−Dᵥ₅₀≥12 μm. Based on a mass of the positive active material layer, a mass percent of the graphene is greater than or equal to 0.05% and less than 0.5%. In some embodiments, with respect to the particles of the positive active material, Dᵥ₉₀−Dᵥ₅₀≤12 μm. Based on a mass of the positive active material layer, a mass percent of the graphene is 0.5% to 1%.

In some embodiments, Dᵥ₅₀ of the graphene is less than Dᵥ₅₀ of the particles of the positive active material. In some embodiments, Dᵥ₉₀ of the graphene is less than Dᵥ₉₀ of the particles of the positive active material.

In some embodiments, in a Raman spectrum of the graphene, an intensity of D peak is I_{D}, an intensity of G peak is I_{G}, and a ratio of I_{D} to I_{G}, expressed as I_{D}/I_{G}, is 0.05 to 0.4.

In some embodiments, the positive active material includes at least one of lithium cobalt oxide, lithium nickel cobalt manganese oxide, lithium nickel cobalt aluminum oxide, or lithium manganese oxide.

In some embodiments, the electrode assembly further includes a negative electrode plate and a separator disposed between the positive electrode plate and the negative electrode plate.

An embodiment of this application further provides an electronic device, including the electrochemical device.

In the embodiments of this application, the graphene is added in the positive active material layer, and at least a part of the graphene is disposed on the surfaces of the particles of the positive active material. The technical solution of this application not only increases a compacted density of the positive active material layer and an energy density of the electrochemical device, but also reduces polarization and increases charging speed of the electrochemical device.

### DETAILED DESCRIPTION

The following embodiments enable a person skilled in the art to understand this application more comprehensively, but without limiting this application in any way.

An embodiment of this application provides an electrochemical device. The electrochemical device includes an electrode assembly. The electrode assembly includes a positive electrode plate. In some embodiments, the positive electrode plate includes a positive current collector and a positive active material layer disposed on the positive current collector. In some embodiments, the positive active material layer is disposed on one side or both sides of the positive current collector. In some embodiments, the positive active material layer includes a positive active material and graphene. At least a part of the graphene is disposed on surfaces of particles of the positive active material.

Understandably, a specific amount of graphene is added in a process of preparing a positive slurry. At least a part of the graphene is dispersed on the surface of the positive active material. In some embodiments, the surface of the positive active material may be coated with the graphene. In some embodiments, the graphene may be dispersed in the positive active material layer.

With the graphene added in the positive active material layer, on the one hand, the graphene on the surface of the positive active material can greatly increase electronic conductivity of the positive active material and increase the charging speed of the electrochemical device. On the other hand, in a cold pressing process, “relative slip” occurs between graphene sheets under the action of a cold pressing pressure to relieve hard contact between the particles of the positive active material. This increases an initial compacted density of the positive electrode plate, reduces the energy density loss caused by the use of small-diameter positive active materials, and increases the energy density of the electrochemical device.

In some embodiments, the positive active material includes primary particles having Dᵥ₅₀≤9 μm and Dᵥ₉₀≤20 μm. The small-diameter positive active material in use can improve the fast charge performance and rate performance of the electrochemical device.

In some embodiments, the positive active material includes secondary particles of which Dᵥ₅₀≤6 μm and Dᵥ₉₀≤15 μm. In some embodiments, some positive active materials, such as lithium nickel cobalt manganese oxide, lithium nickel cobalt aluminum oxide, or lithium manganese oxide, are prone to form secondary particles in the positive active material layer. In some embodiments, the secondary particles are spherical secondary particles. The secondary particles of the small-diameter positive active material in use can improve the fast charge performance and rate performance of the electrochemical device.

In this application, a “primary particle” means a primary structure of a single particle, that is, a monocrystalline particle. A “secondary particle” means an agglomerate in which primary particles aggregate through physical or chemical bonding between the primary particles, that is, a secondary structure.

In this application, a particle diameter may be defined as an average particle diameter Dᵥ₅₀ measured at a cumulative volume of approximately 50% of sample particles in a volume-based particle size distribution curve, or a particle diameter Dᵥ₉₀ measured at a cumulative volume of approximately 90% of sample particles in a volume-based particle size distribution curve. The particle diameter may be measured, for example, by scanning electron microscopy (SEM), field emission scanning electron microscopy (FE-SEM), or laser diffraction electron microscopy. The measurement method based on the laser diffraction microscopy is: dispersing sample particles in a dispersion medium, and then leading the medium into a commercially available laser diffraction particle size measurement device (for example, MasterSizer 2000), and irradiating with ultrasonic waves so that the particle size distribution in the measurement device can be calculated.

In some embodiments, the mass percent of the graphene in the positive active material layer is 0.05% to 1%. If the mass percent of the graphene is exceptionally low, the effects of the graphene in increasing the compacted density of the positive active material layer and in improving the fast charge performance are relatively limited. If the mass percent of the graphene is exceptionally high, the effects of the graphene in increasing the compacted density of the positive active material layer and in improving the fast charge performance do not increase significantly any more, and the energy density of the electrochemical device is reduced.

In some embodiments, with respect to the particles of the positive active material, Dᵥ₉₀−Dᵥ₅₀>12 μm, and the mass percent of the graphene in the positive active material layer is greater than or equal to 0.05% and less than 0.5%. In some embodiments, when the value of Dᵥ₉₀−Dᵥ₅₀ of the particles of the positive active material is relatively large, it indicates that the particle size distribution of the particles of the positive active material is relatively wide, and large particles are well accompanied by small particles, thereby being conducive to cold pressing. When the mass percent of the graphene is relatively low, such a value can still effectively increase the compacted density of the positive active material layer and enhance the fast charge performance. In some embodiments, with respect to the particles of the positive active material, Dᵥ₉₀−Dᵥ₅₀≤12 μm, and the mass percent of the graphene in the positive active material layer is 0.5% to 1%. In some embodiments, when the value of Dᵥ₉₀−Dᵥ₅₀ of the particles of the positive active material is relatively small, it indicates that the particle size distribution of the particles of the positive active material is relatively narrow or concentrated. In this case, a larger amount of graphite is put into use to more sufficiently achieve the purposes of increasing the compacted density of the positive active material layer and enhancing the fast charge performance.

In some embodiments, Dᵥ₅₀ of the graphene is less than Dᵥ₅₀ of the particles of the positive active material. In some embodiments. Dᵥ₉₀ of the graphene is less than Dᵥ₉₀ of the particles of the positive active material. If Dᵥ₅₀ of the graphene is greater than or equal to Dᵥ₅₀ of the particles of the positive active material, or Dᵥ₉₀ of the graphene is greater than or equal to Dᵥ₉₀ of the particles of the positive active material, adverse effects will occur on the homogeneous dispersion of the graphene on the surface of the positive active material. On the other hand, due to a relatively large specific surface area, graphene tends to agglomerate together after being prepared. Large sizes of the agglomerated particles are adverse to the processing of the positive slurry, and adverse to coating the surface of the positive active material with the graphene and dispersing the graphene in the positive active material layer. By setting Dᵥ₅₀ of the graphene to be less than Dᵥ₅₀ of the particles of the positive active material and setting Dᵥ₉₀ of the graphene to be less than Dᵥ₉₀ of the particles of the positive active material, this application disperses the graphene more homogeneously on the surface of the positive active material, thereby more sufficiently achieving the purposes of increasing the compacted density of the positive active material layer and enhancing the fast charge performance.

In some embodiments, in a Raman spectrum of the graphene, an intensity of D peak is I_{D}, an intensity of G peak is 16, and a ratio of I_{D} to I_{G}, expressed as I_{D}/I_{G}, is 0.05 to 0.4. I_{D}/I_{G} may be used to represent the defectiveness of the graphene surface. The higher the I_{D}/I_{G}, the more defective the graphene surface. If I_{D}/I_{G} is too low, the defects on the graphene surface are insufficient, and the ionic conductivity of the graphene will be reduced to some extent. If I_{D}/I_{G} is too high, the defectiveness of the graphene surface is exceptionally high, the relative slip between the graphene sheets will be adversely affected to some extent, thereby making the graphene less effective in increasing the compacted density of the positive active material layer.

In some embodiments, the positive active material includes at least one of lithium cobalt oxide, lithium nickel cobalt manganese oxide, lithium nickel cobalt aluminum oxide, or lithium manganese oxide. In some embodiments, the lithium cobalt oxide usually exists as monocrystalline primary particles in the positive active material layer. In some embodiments, the lithium nickel cobalt manganese oxide, the lithium nickel cobalt aluminum oxide, or the lithium manganese oxide usually exists as spherically agglomerated secondary particles in the positive active material layer. In some embodiments, the positive active material layer may further include a conductive agent. In some embodiments, the conductive agent in the positive active material layer may include at least one of conductive carbon black, Ketjen black, graphite flakes, graphene, carbon nanotubes, or carbon fiber. In some embodiments, the positive active material layer may further include a binder. The binder in the positive active material layer may include at least one of carboxymethyl cellulose (CMC), polyacrylic acid, polyvinylpyrrolidone, polyaniline, polyimide, polyamideimide, polysiloxane, styrene butadiene rubber, epoxy resin, polyester resin, polyurethane resin, or polyfluorene. In some embodiments, a mass ratio of the positive active material, the conductive agent, and the binder in the positive active material layer may be (80 to 99):(0.1 to 10):(0.1 to 10). In some embodiments, the thickness of the positive active material layer may be 10 μm to 200 μm. Understandably, what is described above is merely an example, and the positive active material layer of the positive electrode may adopt any other appropriate material, thickness, and mass ratio.

In some embodiments, the positive current collector may be an aluminum foil, or may be another current collector commonly used in the art. In some embodiments, the thickness of the positive current collector may be 1 μm to 100 μm. In some embodiments, the positive active material layer may be coated on merely a local region of the positive current collector.

In some embodiments, the electrochemical device may further include a negative electrode plate and a separator disposed between the positive electrode plate and the negative electrode plate. In some embodiments, the negative electrode plate includes a negative current collector and a negative active material layer disposed on the negative current collector. In some embodiments, the negative active material layer is disposed on one side or both sides of the negative current collector. In some embodiments, the negative active material layer includes a negative active material. The negative active material may include at least one of graphite, hard carbon, silicon, silicon suboxide, or organosilicon. In some embodiments, the negative active material layer may further include a conductive agent and a binder. In some embodiments, the conductive agent in the negative active material layer may include at least one of conductive carbon black, Ketjen black, graphite flakes, graphene, carbon nanotubes, or carbon fiber. In some embodiments, the binder in the negative active material layer may include at least one of carboxymethyl cellulose (CMC), polyacrylic acid, polyvinylpyrrolidone, polyaniline, polyimide, polyamideimide, polysiloxane, styrene butadiene rubber, epoxy resin, polyester resin, polyurethane resin, or polyfluorene. In some embodiments, a mass ratio of the positive active material, the conductive agent, and the binder in the positive active material layer may be (80 to 98):(0.1 to 10):(0.1 to 10). Understandably, what is enumerated above is merely an example, and any other appropriate material and mass ratio may apply. In some embodiments, the negative current collector may be at least one of a copper foil, a nickel foil, or a carbon-based current collector.

In some embodiments, the separator includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially the polyethylene and the polypropylene are highly effective in preventing short circuits, and improve stability of the battery through a turn-off effect. In some embodiments, the thickness of the separator is within a range of approximately 5 μm to 50 μm.

In some embodiments, a porous layer may be further included in a surface of the separator. The porous layer is disposed on at least one surface of a substrate of the separator. The porous layer includes inorganic particles and a binder. The inorganic particles is at least one selected from aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, a diameter of a pore of the separator is within a range of approximately 0.01 μm to 1 μm. The binder in the porous layer is at least one selected from polyvinylidene difluoride, a vinylidene difluoride-hexafluoropropylene copolymer, a polyamide, polyacrylonitrile, polyacrylic ester, polyacrylic acid, sodium polyacrylate, sodium carboxymethyl cellulose, polyvinylpyrrolidone, polyvinyl ether, poly methyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrode assembly of the electrochemical device is a jelly-roll electrode assembly, a stacked electrode assembly, or a folded electrode assembly. In some embodiments, the positive electrode and/or negative electrode of the electrochemical device may be a multi-layer structure formed by winding or stacking, or may be a single-layer structure formed by stacking a single layer of positive electrode, a separator, and a single layer of negative electrode.

In some embodiments, the electrochemical device includes, but is not limited to, a lithium-ion battery. In some embodiments, the electrochemical device may further include an electrolyte. The electrolyte may be one or more of a gel electrolyte, a solid-state electrolyte, and an electrolytic solution. The electrolytic solution includes a lithium salt and a nonaqueous solvent. The lithium salt is at least one selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆ because it is of a high ionic conductivity and can improve cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1, 2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, fonmamide, dimethylformamide, acetonitrile, trimethyl phosphate, triethyl phosphate, trioctyl phosphate, phosphate ester, or any combination thereof.

In some embodiments of this application, using a lithium-ion battery as an example, the lithium-ion battery is prepared by: winding or stacking the positive electrode, the separator, and the negative electrode sequentially into an electrode assembly, putting the electrode assembly into a package such as an aluminum plastic film ready for sealing, injecting an electrolytic solution, and performing chemical formation and sealing, Then a performance test is performed on the prepared lithium-ion battery.

A person skilled in the art understands that the method for preparing the electrochemical device (for example, the lithium-ion battery) described above is merely an example. To the extent not departing from the content disclosed herein, other methods commonly used in the art may be used.

An embodiment of this application further provides an electronic device containing the electrochemical device. The electronic device according to the embodiments of this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

Some specific embodiments and comparative embodiments are enumerated below to give a clearer description of this application, using a lithium-ion battery as an example.

### Embodiment 1

Preparing a positive electrode plate: Using an aluminum foil as a positive current collector, and dissolving lithium cobalt oxide as a positive active material, conductive carbon black as a conductive agent, and polyvinylidene difluoride as a binder at a mass ratio of 96:2.2:1.2 in an N-methyl-pyrrolidone (NMP) solution to form an elementary slurry. Adding graphene into the elementary slurry and stirring to form a positive active material layer slurry, so that the mass ratio between the lithium cobalt oxide, the conductive carbon black as a conductive agent, the polyvinylidene difluoride as a binder, and the graphene is 96:2.2:1.2:0.6. Coating the positive current collector with the positive active material layer slurry at a thickness of 120 μm to obtain a positive active material layer. Performing drying, cold pressing, and cutting to obtain a positive electrode. The compacted density of the positive active material layer is 4.1 g/cm³.

Preparing a negative electrode plate: Dissolving artificial graphite, acetylene black, sodium carboxymethyl cellulose (CMC), and the binder styrene butadiene rubber at a mass ratio of 96:1:1.5:1.5 in deionized water to form a negative slurry. Using a 10 μm-thick copper foil as a negative current collector, coating the negative current collector with the negative slurry, and performing drying and cutting to obtain a negative electrode plate.

Preparing a separator: Using 8 μm-thick polyethylene (PE) as a substrate of the separator, coating both sides of the substrate of the separator with a 2 μm-thick aluminum oxide ceramic layer. Finally, coating polyvinylidene difluoride (PVDF) as a binder in an amount of 2.5 mg/cm² onto both sides that have been coated with the ceramic layer, and performing drying.

Preparing an electrolytic solution: Adding LiPF₆ into a nonaqueous organic solvent in an environment in which a water content is less than 10 ppm, where the mass ratio between ingredients of the nonaqueous organic solvent is ethylene carbonate (EC): diethyl carbonate (DEC): propylene carbonate (PC): propyl propionate (PP): vinylene carbonate (VC)=20:30:20:28:2, and the concentration of the LiPF₆ is 1.15 mol/L; and mixing the solution evenly to obtain an electrolytic solution.

Preparing a lithium-ion battery: Stacking the positive electrode, the separator, and the negative electrode sequentially so that the separator is located between the positive electrode and the negative electrode to serve a function of separation, and winding the stacked plates to obtain an electrode assembly. Putting the electrode assembly in an aluminum plastic film that serves as an outer package, dehydrating the electrode assembly under 80° C., injecting the electrolytic solution, and performing sealing; and performing steps such as chemical formation, degassing, and edge trimming to obtain a lithium-ion battery.

The steps in the embodiments and comparative embodiments are the same as those in Embodiment 1 except changed parameter values. The specific changed parameter values are shown in the following table.

The following describes the testing method of each parameter in this application.

Testing the particle diameters:

Adding approximately 0.02 gram of powder sample into a 50 ml-sized clean beaker, adding approximately 20 ml of deionized water, and adding a few drops of 1% surfactant dropwise to make the powder fully dispersed in water: ultrasonically cleaning the sample in a 120 W ultrasonic cleaning machine for 5 minutes; testing the particle size distribution by using a MasterSizer 2000; and obtaining Dᵥ₅₀ and Dᵥ₉₀ by testing with a laser scattering particle size analyzer, where Dᵥ₅₀ and Dᵥ₉₀ are particle diameters measured at a cumulative volume of 50% and 90%, respectively, in a volume-based particle size distribution.

Testing the capacity retention rate of the battery discharged at a 3 C rate:

Putting a lithium-ion battery into a 25° C.±2° C. thermostat, leaving the battery to stand for 2 hours, charging the battery at a 1 C rate until the voltage reaches 4.48 V, and then charging the battery at a constant voltage of 4.48 V until the current reaches 0.05 C. Performing a cycle performance test by discharging the battery at a 0.2 C rate until the voltage reaches 3.0 V, so that a reference discharge capacity is obtained; and performing a cycle performance test by discharging the battery at a 3 C rate until the voltage reaches 3.0 V, so that an actual discharge capacity is obtained.

Capacity retention rate of the battery discharged at a 3 C rate=actual discharge capacity/reference discharge capacity×100%.

Testing the compacted density:

Punching out a wafer coated with the positive active material layer and an empty aluminum foil that is A mm² in area by using a punching machine. Measuring the thickness of the wafer and the thickness of the empty aluminum foil with a micrometer, recorded as H and h (mm) respectively; weighing to obtain the mass of the wafer recorded as M (g) and the mass of the empty aluminum foil recorded as m (g). Compacted density=((M−m)/(A×(H−h)))×1000 (g/cm³).

Testing the full-charge time:

Putting a completely assembled lithium-ion battery into a 25° C.±2° C. thermostat, charging the battery at a 1 C rate until the voltage reaches 4.48 V, and then charging the battery at a constant voltage of 4.48 V until the current reaches 0.05 C. Recording the charging time, which is the full-charge time.

Table I shows parameters and evaluation results in Embodiments 1 to 35 and Comparative Embodiments 1 to 3. For ease of description, the embodiments are shown in groups. The types and particle diameters of the positive active materials as well as the mass percent of graphene in Embodiments 2 and 3 are different from those in Embodiment 1. No graphene is added in Comparative Embodiments 1 to 3. The types and particle diameters of the positive active material in Comparative Embodiments 2 and 3 are different from those in Embodiment 1.

The particle diameters of the positive active materials in Embodiments 4 to 7 and Comparative Embodiment 4 are different from those in Embodiment 1. The particle diameters of the positive active materials in Embodiment 8 are different from those in Embodiment 2. The particle diameters of the positive active materials in Embodiments 9 to 11 are different from those in Embodiment 3.

The mass percent of graphene in Embodiments 12 to 16 is different from that in Embodiment 4. The particle diameters of the positive active materials and the mass percent of graphene in Embodiments 17 to 21 are different from those in Embodiment 4.

The particle diameter of graphene in Embodiments 16 to 17 and Comparative Embodiment 11 is different from that in Embodiment 1. The particle diameters of the positive active materials and the particle diameter of graphene in Embodiments 18 to 19 and Comparative Embodiment 12 are different from those in Embodiment 1.

The particle diameter of graphene in Embodiments 22 to 24 is different from that in Embodiment 4, and the particle diameter of graphene in Embodiments 25 to 27 is different from that in Embodiment 19.

The I_{D}/I_{G} of graphene in Embodiments 28 to 31 is different from that in Embodiment 19, and the I_{D}/I_{G} of graphene in Embodiments 32 to 35 is different from that in Embodiment 27.

TABLE 1

| | | Morphology of | Dᵥ₅₀ of | Dᵥ₉₀ of | | Dᵥ₅₀ of |
|---|---|---|---|---|---|---|
| | Positive active | positive active | positive active | positive active | Mass percent | graphene |
| | material | material | material (μm) | material (μm) | of graphene | (μm) |
| Comparative | Lithium cobalt | Primary | 15 | 29 | / | / |
| Embodiment 1 | oxide | particles | | | | |
| Comparative | Lithium manganese | Secondary | 12 | 25 | / | / |
| Embodiment 2 | oxide | particles | | | | |
| Comparative | Lithium nickel | Secondary | 12 | 25 | / | / |
| Embodiment 3 | cobalt manganese | particles | | | | |
| | oxide | | | | | |
| Embodiment 1 | Lithium cobalt | Primary | 15 | 29 | 0.6% | 4 |
| | oxide | particles | | | | |
| Embodiment 2 | Lithium manganese | Secondary | 12 | 25 | 0.5% | 3 |
| | oxide | particles | | | | |
| Embodiment 3 | Lithium nickel | Secondary | 12 | 25 | 0.5% | 3 |
| | cobalt manganese | particles | | | | |
| | oxide | | | | | |
| Embodiment 1 | Lithium cobalt | Primary | 15 | 29 | 0.6% | 4 |
| | oxide | particles | | | | |
| Embodiment 4 | Lithium cobalt | Primary | 9 | 20 | 0.6% | 4 |
| | oxide | particles | | | | |
| Embodiment 5 | Lithium cobalt | Primary | 9 | 15 | 0.6% | 4 |
| | oxide | particles | | | | |
| Embodiment 6 | Lithium cobalt | Primary | 8.5 | 20 | 0.6% | 4 |
| | oxide | particles | | | | |
| Embodiment 7 | Lithium cobalt | Primary | 7 | 18 | 0.6% | 4 |
| | oxide | particles | | | | |
| Embodiment 2 | Lithium manganese | Secondary | 12 | 25 | 0.5% | 3 |
| | oxide | particles | | | | |
| Embodiment 8 | Lithium manganese | Secondary | 6 | 15 | 0.5% | 3 |
| | oxide | particles | | | | |
| Embodiment 3 | Lithium nickel | Secondary | 12 | 25 | 0.5% | 3 |
| | cobalt manganese | particles | | | | |
| | oxide | | | | | |
| Embodiment 9 | Lithium nickel | Secondary | 6 | 14 | 0.5% | 3 |
| | cobalt manganese | particles | | | | |
| | oxide | | | | | |
| Embodiment 10 | Lithium nickel | Secondary | 5 | 15 | 0.5% | 3 |
| | cobalt manganese | particles | | | | |
| | oxide | | | | | |
| Embodiment 11 | Lithium nickel | Secondary | 4 | 10 | 0.5% | 3 |
| | cobalt manganese | particles | | | | |
| | oxide | | | | | |
| Embodiment 12 | Lithium cobalt | Primary | 9 | 20 | 0.2% | 4 |
| | oxide | particles | | | | |
| Embodiment 13 | Lithium cobalt | Primary | 9 | 20 | 0.5% | 4 |
| | oxide | particles | | | | |
| Embodiment 4 | Lithium cobalt | Primary | 9 | 20 | 0.6% | 4 |
| | oxide | particles | | | | |
| Embodiment 14 | Lithium cobalt | Primary | 9 | 20 | 0.8% | 4 |
| | oxide | particles | | | | |
| Embodiment 15 | Lithium cobalt | Primary | 9 | 20 | 1.0% | 1 |
| | oxide | particles | | | | |
| Embodiment 16 | Lithium cobalt | Primary | 9 | 20 | 2.0% | 4 |
| | oxide | particles | | | | |
| Embodiment 17 | Lithium cobalt | Primary | 6 | 19 | 0.02% | 4 |
| | oxide | particles | | | | |
| Embodiment 18 | Lithium cobalt | Primary | 6 | 19 | 0.05% | 4 |
| | oxide | particles | | | | |
| Embodiment 19 | Lithium cobalt | Primary | 6 | 19 | 0.3% | 4 |
| | oxide | particles | | | | |
| Embodiment 20 | Lithium cobalt | Primary | 6 | 19 | 0.5% | 4 |
| | oxide | particles | | | | |
| Embodiment 21 | Lithium cobalt | Primary | 6 | 19 | 0.8% | 4 |
| | oxide | particles | | | | |
| Embodiment 4 | Lithium cobalt | Primary | 9 | 20 | 0.6% | 4 |
| | oxide | particles | | | | |
| Embodiment 22 | Lithium cobalt | Primary | 9 | 20 | 0.6% | 9 |
| | oxide | particles | | | | |
| Embodiment 23 | Lithium cobalt | Primary | 9 | 20 | 0.6% | 7 |
| | oxide | particles | | | | |
| Embodiment 24 | Lithium cobalt | Primary | 9 | 20 | 0.6% | 11 |
| | oxide | particles | | | | |
| Embodiment 25 | Lithium nickel | Secondary | 6 | 15 | 0.5% | 8 |
| | cobalt manganese | particles | | | | |
| | oxide | | | | | |
| Embodiment 26 | Lithium nickel | Secondary | 6 | 15 | 0.5% | 6 |
| | cobalt manganese | particles | | | | |
| | oxide | | | | | |
| Embodiment 19 | Lithium nickel | Secondary | 6 | 15 | 0.5% | 4 |
| | cobalt manganese | particles | | | | |
| | oxide | | | | | |
| Embodiment 27 | Lithium nickel | Secondary | 6 | 15 | 0.5% | 3 |
| | cobalt manganese | particles | | | | |
| | oxide | | | | | |
| Embodiment 28 | Lithium cobalt | Primary | 6 | 19 | 0.3% | 4 |
| | oxide | particles | | | | |
| Embodiment 29 | Lithium cobalt | Primary | 6 | 19 | 0.3% | 4 |
| | oxide | particles | | | | |
| Embodiment 19 | Lithium cobalt | Primary | 6 | 19 | 0.3% | 4 |
| | oxide | particles | | | | |
| Embodiment 30 | Lithium cobalt | Primary | 6 | 19 | 0.3% | 4 |
| | oxide | particles | | | | |
| Embodiment 31 | Lithium cobalt | Primary | 6 | 19 | 0.3% | 4 |
| | oxide | particles | | | | |
| Embodiment 32 | Lithium nickel | Secondary | 6 | 15 | 0.5% | 3 |
| | cobalt manganese | particles | | | | |
| | oxide | | | | | |
| Embodiment 33 | Lithium nickel | Secondary | 6 | 15 | 0.5% | 3 |
| | cobalt manganese | particles | | | | |
| | oxide | | | | | |
| Embodiment 27 | Lithium nickel | Secondary | 6 | 15 | 0.5% | 3 |
| | cobalt manganese | particles | | | | |
| | oxide | | | | | |
| Embodiment 34 | Lithium nickel | Secondary | 6 | 15 | 0.5% | 3 |
| | cobalt manganese | particles | | | | |
| | oxide | | | | | |
| Embodiment 35 | Lithium nickel | Secondary | 6 | 15 | 0.5% | 3 |
| | cobalt manganese | particles | | | | |
| | oxide | | | | | |

| | | | Compacted density | Full- | Capacity retention |
|---|---|---|---|---|---|
| | Dᵥ₉₀ of | | of positive | charge | rate of battery |
| | graphene | I_{D}/I_{G} of | electrode plate | time | discharged at |
| | (μm) | graphene | (g/cm³) | (min) | 3 C rate |
| Comparative | / | / | 3.85 | 71.3 | 87.0% |
| Embodiment 1 | | | | | |
| Comparative | / | / | 2.9 | 72.5 | 89.4% |
| Embodiment 2 | | | | | |
| Comparative | / | / | 3.1 | 71.0 | 88.7% |
| Embodiment 3 | | | | | |
| Embodiment 1 | 15 | 0.25 | 4.1 | 70.1 | 89.0% |
| Embodiment 2 | 10 | 0.25 | 3.05 | 71.0 | 90.3% |
| Embodiment 3 | 10 | 0.25 | 3.3 | 69.5 | 89.9% |
| Embodiment 1 | 15 | 0.25 | 4.1 | 70.1 | 89.0% |
| Embodiment 4 | 15 | 0.25 | 4.1 | 67.3 | 91.2% |
| Embodiment 5 | 15 | 0.25 | 4.05 | 68.0 | 90.5% |
| Embodiment 6 | 15 | 0.25 | 4.05 | 68.0 | 90.5% |
| Embodiment 7 | 15 | 0.25 | 4.0 | 67.5 | 91.0% |
| Embodiment 2 | 10 | 0.25 | 3.05 | 71.0 | 85.2% |
| Embodiment 8 | 10 | 0.25 | 3.0 | 68.3 | 90.3% |
| Embodiment 3 | 10 | 0.25 | 3.3 | 69.5 | 89.9% |
| Embodiment 9 | 10 | 0.25 | 3.1 | 68.5 | 92.0% |
| Embodiment 10 | 10 | 0.25 | 3.05 | 68.0 | 92.0% |
| Embodiment 11 | 10 | 0.25 | 3.05 | 67.0 | 92.6% |
| Embodiment 12 | 15 | 0.25 | 3.95 | 67.3 | 90.1% |
| Embodiment 13 | 15 | 0.25 | 4.05 | 68.0 | 91.1% |
| Embodiment 4 | 15 | 0.25 | 4.1 | 67.3 | 91.2% |
| Embodiment 14 | 15 | 0.25 | 4.1 | 66.5 | 93.0% |
| Embodiment 15 | 15 | 0.25 | 4.1 | 67.7 | 92.1% |
| Embodiment 16 | 15 | 0.25 | 3.85 | 72.0 | 87.3% |
| Embodiment 17 | 15 | 0.25 | 3.9 | 70.1 | 90.1% |
| Embodiment 18 | 15 | 0.25 | 4.05 | 68.5 | 91.2% |
| Embodiment 19 | 15 | 0.25 | 4.1 | 68.0 | 92.7% |
| Embodiment 20 | 15 | 0.25 | 4.1 | 68.0 | 92.5% |
| Embodiment 21 | 15 | 0.25 | 4.0 | 69.7 | 89.3% |
| Embodiment 4 | 15 | 0.25 | 4.1 | 67.3 | 91.2% |
| Embodiment 22 | 20 | 0.25 | 4.05 | 66.4 | 91.9% |
| Embodiment 23 | 17 | 0.25 | 4.1 | 67.1 | 90.8% |
| Embodiment 24 | 23 | 0.25 | 3.9 | 72.0 | 87.6% |
| Embodiment 25 | 17 | 0.25 | 4.0 | 71.8 | 88.5% |
| Embodiment 26 | 15 | 0.25 | 3.1 | 66.0 | 91.4% |
| Embodiment 19 | 13 | 0.25 | 3.1 | 66.2 | 91.0% |
| Embodiment 27 | 10 | 0.25 | 3.1 | 66.3 | 92.5% |
| Embodiment 28 | 15 | 0.02 | 4.1 | 71.2 | 88.5% |
| Embodiment 29 | 15 | 0.05 | 4.1 | 69 | 91.7% |
| Embodiment 19 | 15 | 0.25 | 4.1 | 68.0 | 92.7% |
| Embodiment 30 | 15 | 0.4 | 4.1 | 68.4 | 89.5% |
| Embodiment 31 | 15 | 0.7 | 4.1 | 71.9 | 88.3% |
| Embodiment 32 | 10 | 0.02 | 3.1 | 70.2 | 89.3% |
| Embodiment 33 | 10 | 0.05 | 3.1 | 66.8 | 92.3% |
| Embodiment 27 | 10 | 0.25 | 3.1 | 66.3 | 92.5% |
| Embodiment 34 | 10 | 0.4 | 3.1 | 65 | 93.1% |
| Embodiment 35 | 10 | 0.7 | 3.1 | 69.9 | 88.7% |

In the table above, “/” means that the substance is not added or the parameter is not applicable.

As can be seen from comparison between Embodiment 1 and Comparative Embodiment 1, with the graphene added in the positive active material layer, the surfaces of at least a part of the particles of the positive active material are coated with graphene, so that the compacted density of the positive electrode plate increases, and the full-charge time of the electrochemical device is reduced, and the capacity retention rate is improved. The same results can be obtained by comparing Embodiment 2 with Comparative Embodiment 2 or comparing Embodiment 3 with Comparative Embodiment 3.

As can be seen from Embodiments 1 to 3, no matter whether the positive active material is primary particles or secondary particles, the graphene added can increase compacted density and improve the fast charge performance and the capacity retention rate.

As can be seen from comparison between Embodiment 1 and Embodiments 4 to 7, when the particles of the positive active material are primary particles having Dᵥ₅₀≤9 μm and Dᵥ₉₀≤20 μm, the full-charge time is further shortened, and the capacity retention rate is further increased. As the particle diameter of the positive active material decreases, the compacted density of the positive electrode plate shows a tendency to decrease. However, with the graphene added, the decrease of the compacted density is not significant.

As can be seen from comparison between Embodiment 2 and Embodiments 8 and comparison between Embodiment 3 and Embodiments 9 to 11, when the particles of the positive active material are secondary particles of which Dᵥ₅₀≤6 μm and Dᵥ₉₀≤15 μm, the full-charge time is further shortened, and the capacity retention rate is further increased. As the particle diameter of the positive active material decreases, the compacted density of the positive electrode plate shows a tendency to decrease. However, with the graphene added, the decrease of the compacted density is not significant.

As can be seen from comparison between Embodiment 4 and Embodiments 12 to 16, when Dᵥ₉₀−Dᵥ₅₀ of the particles of the positive active material is less than or equal to 12 μm, the particle diameter range of the particles of the positive active material is relatively narrow, and the compacted density of the positive electrode plate is relatively low. When the graphene at a mass percent of 0.5% to 1% is added into the positive active material layer, the compacted density of the positive electrode plate can be increased, the full-charge time is relatively short, and the capacity retention rate is relatively high.

As can be seen from comparison between Embodiments 17 to 21, when Dᵥ₉₀−Dᵥ₅₀ of the particles of the positive active material is greater than 12 μm, the particle diameter range of the particles of the positive active material is relatively wide, and the compacted density of the positive electrode plate is relatively high. In this case, When the graphene at a mass percent greater than or equal to 0.05% and less than 0.5% is added into the positive active material layer, the full-charge time is shortened and the capacity retention rate is increased on the basis of ensuring a relatively high compacted density of the positive electrode plate, but without reducing the content of the positive active material in the positive active material layer.

As can be seen from comparison between Embodiment 4 and Embodiments 22 to 24 and comparison between Embodiment 19 and Embodiments 25 to 27, as the particle diameter of the graphene increases, the compacted density of the positive electrode plate decreases. In addition, when Dᵥ₅₀ of the graphene is greater than Dᵥ₅₀ of the positive active material or Dᵥ₉₀ of the graphene is greater than Dᵥ₉₀ of the positive active material, the compacted density of the positive electrode plate decreases, and the full-charge time and the capacity retention rate of the electrochemical device deteriorate. When Dᵥ₅₀ of the graphene is less than Dᵥ₅₀ of the positive active material or Dᵥ₉₀ of the graphene is less than Dᵥ₉₀ of the positive active material, the compacted density of the positive electrode plate is further increased, the full-charge time is further shortened, and the capacity retention rate of the electrochemical device is further increased.

As can be seen from comparison between Embodiment 19 and Embodiments 28 to 31, when the I_{D}/I_{G} of the graphene is 0.05 to 0.4, defectiveness of the graphene is maintained to some extent, thereby helping to improve conductivity, shortening the full-charge time, and increasing the capacity retention rate of the electrochemical device, but without affecting the compacted density of the positive electrode plate. The same results can be obtained by comparing Embodiment 27 and Embodiments 32 to 35.

The foregoing descriptions are merely about exemplary embodiments of this application and the technical principles applied. A person skilled in the art understands that the scope of disclosure in this application is not limited to the technical solutions formed by a specific combination of the foregoing technical features, but also covers other technical solutions formed by arbitrarily combining the foregoing technical features or equivalents thereof, for example, a technical solution formed by replacing any of the foregoing features with a technical feature disclosed herein and serving similar functions.

What is claimed is:

1. An electrochemical device, comprising an electrode assembly, wherein the electrode assembly comprises a positive electrode plate, and the positive electrode plate comprises:
a positive current collector; and
a positive active material layer disposed on the positive current collector, wherein the positive active material layer comprises a positive active material and graphene, and at least a part of the graphene is disposed on surfaces of particles of the positive active material.

2. The electrochemical device according to claim 1, wherein the positive active material comprises primary particles having Dᵥ₅₀≤9 μm and Dᵥ₉₀≤20 μm.

3. The electrochemical device according to claim 1, wherein the positive active material comprises secondary particles having Dᵥ₅₀≤6 μm and Dᵥ₉₀≤15 μm.

4. The electrochemical device according to claim 1, wherein, with respect to the particles of the positive active material. Dᵥ₉₀−Dᵥ₅₀>12 μm; and, based on a mass of the positive active material layer, a mass percent of the graphene is greater than or equal to 0.05% and less than 0.5%.

5. The electrochemical device according to claim 1, wherein, with respect to the particles of the positive active material, Dᵥ₉₀−Dᵥ₅₀≤12 μm; and, based on a mass of the positive active material layer, a mass percent of the graphene is 0.5% to 1%.

6. The electrochemical device according to claim 1, wherein Dᵥ₅₀ of the graphene is less than Dᵥ₅₀ of the particles of the positive active material.

7. The electrochemical device according to claim 1, wherein Dᵥ₉₀ of the graphene is less than Dᵥ₉₀ of the particles of the positive active material.

8. The electrochemical device according to claim 1, wherein, in a Raman spectrum of the graphene, an intensity of D peak is I_{D}, an intensity of G peak is I_{G}, and a ratio of I_{D} to I_{G}, expressed as I_{D}/I_{G}, is 0.05 to 0.4.

9. The electrochemical device according to claim 1, wherein the positive active material comprises at least one of lithium cobalt oxide, lithium nickel cobalt manganese oxide, lithium nickel cobalt aluminum oxide, or lithium manganese oxide.

10. An electronic device, comprising an electrochemical device, wherein the electrochemical device comprises an electrode assembly, the electrode assembly comprises a positive electrode plate, and the positive electrode plate comprises:
a positive current collector; and
a positive active material layer disposed on the positive current collector, wherein the positive active material layer comprises a positive active material and graphene, and at least a part of the graphene is disposed on surfaces of particles of the positive active material.

11. The electronic device according to claim 10, wherein the positive active material comprises primary particles having Dᵥ₅₀≤9 μm and Dᵥ₉₀≤20 μm.

12. The electronic device according to claim 10, wherein the positive active material comprises secondary particles having Dᵥ₅₀≤6 μm and Dᵥ₉₀≤15 μm.

13. The electronic device according to claim 10, wherein, with respect to the particles of the positive active material, Dᵥ₉₀−Dᵥ₅₀>12 μm; and, based on a mass of the positive active material layer, a mass percent of the graphene is greater than or equal to 0.05% and less than 0.5%.

14. The electronic device according to claim 10, wherein, with respect to the particles of the positive active material, Dᵥ₉₀−Dᵥ₅₀≤12 μm; and, based on a mass of the positive active material layer, a mass percent of the graphene is 0.5% to 1%.

15. The electronic device according to claim 10, wherein Dᵥ₅₀ of the graphene is less than Dᵥ₅₀ of the particles of the positive active material.

16. The electronic device according to claim 10, wherein Dᵥ₉₀ of the graphene is less than Dᵥ₉₀ of the particles of the positive active material.

17. The electronic device according to claim 10, wherein, in a Raman spectrum of the graphene, an intensity of D peak is I_{D}, an intensity of G peak is I_{G}, and a ratio of I_{D} to I_{G}, expressed as I_{D}/I_{G}, is 0.05 to 0.4.

18. The electronic device according to claim 10, wherein the positive active material comprises at least one of lithium cobalt oxide, lithium nickel cobalt manganese oxide, lithium nickel cobalt aluminum oxide, or lithium manganese oxide.
